(19) United States
(12) Patent Application Publication
(10) Pub. No.: US 2016/0093417 A1
(43) Pub. Date: Mar. 31, 2016

(54) MOBILE DEVICE CABLE STRENGTHENING AND PERSONALIZATION DEVICE AND METHOD

(71) Applicants: James Clifford Litterini, River Edge, NJ (US); Cameron Lynne Litterini, River Edge, NJ (US)

(72) Inventors: James Clifford Litterini, River Edge, NJ (US); Cameron Lynne Litterini, River Edge, NJ (US)

(21) Appl. No.: 14/499,197

(22) Filed: Sep. 28, 2014

(51) Int. Cl. H01B 7/17

(52) U.S. Cl. CPC H01B 7/17

(57) ABSTRACT

A cable strengthening and personalization device and method for use with cables round, flat or with contemporous shape for devices which include smart phones, smart watches, inductive smart device chargers, tablet computers, MP3 media players, mobile phones, digital recording devices both audio and video, global positioning devices, game controllers and other devices that use a USB or other type plug on the power facing end and iPhone lightening, phone plug, USB standard A, mini or micro USB type or other type plug on the device end is herein disclosed. The device components are designed to strengthen and customize existing device connection cables in the area of, just adjacent to and along the entire existing cable length without dismantling such cables nor impact the usability especially in the applications where limited space exists and enhance the durability and or appearance of the existing cables, plug and power supplies (AC to DC converters or DC). The components of the device can be assembled in a hot or cold manual, semi-automated or automated process without dismantling the components of the cable under enhancement. Among other things the strengthening and personalization components reduce the effect of mechanical forces including cutting, abrasion, axial and longitudinal which results in extension of the service life of said cable, allows the user to easily identify said cable among a host of similar cables and express their individuality through a plethora of colors and images to customize the plug surfaces, entire cable body and AC power supply to meet the preference of the user.

### REFERENCES CITED

### United States Patents

| | | |
|---|---|---|
| 20130270002 A1 | October 2013 | Fawcet et al. |
| 2013/0327559 A1 | December 2013 | Kim et al. |
| 2013/0244491 A1 | September 2013 | Sarwar et al. |
| 7,537,488 B2 | May 2009 | Iwakawa |
| 8,435,067 B2 | May 2013 | Wegener |
| 3,757,031 | September 1973 | Izraeli. |
| 2012/0272816 A1 | November 2012 | Ueda et al. |
| 5,914,160B | June 1999 | Matsufuji et al. |
| 2014/0209353 A1 | July 2014 | Lietz et al. |

### FIELD

This invention applies to the cable between a mobile device and the AC to DC power supply as seen in FIG. 2, inclusive, for devices referred to as mobile devices especially smart phones, smart watches, inductive smart device chargers tablet computers, MP3 media players, mobile phones, digital recording devices both audio and video, global positioning devices, game controllers and other devices that use a flexible round, flat cable containing two or more electrical conductors as seen in FIG. 1 or some other shape to connect the mobile device or docking station on the upstream host device side with the cable using some standard or propriety plug such as a USB type A or similar on the downstream power end to a power source and in the case of a self contained power source such as an AC to DC power supply and on the upstream host device end some standard or proprietary plug such as a micro B and phone plug or iPhone lightening, respectively, to the host device.

### BACKGROUND

In recent years supported by faster cellular networks, longer lasting batteries, ever increasing need to consume and store data mobile devices have proliferated and in turn the power they consume has increased necessitating the need to transfer power in addition to data with sufficient reliability via a flexible multi pin cable. Keeping the devices powered presents two problems: longevity and personalization.

First, due to the desire of the cable manufacturer to keep the power cable light, cost effective and conforming to a certain minimalistic appearance the cables are often designed and or manufactured with inadequate strength in the area of the plug to cable interface and along the entire cable length to handle the axial, bending, cutting, abrasive and other various mechanical forces to which the device is routinely subjected especially in the case of the smaller and often proprietary mobile device plug and where sufficient space does not exist for the user to readily handle the plug during insertion and removal so the cable is handled instead which results in premature failure of the cable often when the mobile device is most needed. The cable functionality fails as the leads pull out of the pins or solder as seen in FIG. 4, the leads break at the plug as seen in FIG. 5, circuit board or cable interface or at any point along the entire length of the cable as seen in FIGS. 6 and 7. To correct these cable performance failures requires additional strengthening which minimally impacts the cables flexibility, weight and appearance yet enhances its durability. Adding such strengthening must be minimally invasive and not require modification to the existing cable such as removal and reattachment of the cable plugs. As such the strengthening components must slip over and readily attach to the existing cable components and this work must be suitable for a user that is performing the installation with minimal experience other than viewing a video or reading assembly instructions to provide maximal utility.

Second, it has become quite common for numerous users to plug their cables and AC supplies used inside and outside of North America into common areas leaving the cable “plugged in” for short to longer duration and not attached to the mobile device. Since the cables and their power supplies are not readily differentiated often a user cannot distinguish their cable and AC adapter among similar items.

Additionally, there exists out of a common need for individuality and self-expression which is the same need that in often times the user purchased the particular device instead of another somewhat technically equivalent device a user wants to personalize his device which has the unintended consequence of solving item two and makes the cable and AC adapter readily identifiable among a host of similar cables and power supplies.

### SUMMARY

The present device is comprised of embodiments to strengthen and to personalize mobile device cables as seen in FIG. 17. The embodiments do not interfere with any pre-existing electronics such as circuit boards or pins but in fact are intended to protect these and or enhance physically and or in appearance.

In the first embodiment as seen in FIG. 9 the plug enclosure device is made of any number of formulations of plastic and in any common manufacturing process such as injection molding or additive manufacturing. One of the essential components consists of a single custom low physical profile form fitting connection with integral cable stress relief for both the mobile device side and AC power side plugs.

In a second embodiment as seen in FIG. 12 the components are assembled in an entirely cold process.

Other essential components as seen in FIG. 15 include a sheath that protects the cable body and provides personalization in addition to images which personalize the USB A plug and AC power supply.

The operational principle of each embodiment remains the same regardless of which USB variant, jack or custom plug such as iPhone lightening to which the device conforms. In operation the custom plug enclosure fits over and readily affixes to the existing plug, cable and to a cable protecting sheath via a ratcheting and locking mechanism contained on the main plug body and on the integral stress relief. The custom plug enclosure then securely grasps the existing plug and cable and cable to the protective and personalization sheath component via the compressive forces generated by the ratcheting mechanism which accommodates the range of possible cable diameters in conjunction with an inner adhesive liner.

The sheath, one embodiment seen in FIG. 18 item 1, is made of a fibrous somewhat accommodating material constructed from but not limited to PTFE, Kevlar, Carbon or metal commonly referred to as braid or wire wrapping. The braid or wire wrapping material expands and is pulled over the OEM plug end to the required length by a manual, semi-automated or automated process and covers the cable, then is secured either by the distal portion of the embodiments of the enclosure device.

The spiral wrapping, one embodiment seen in FIG. 18 item 2 is constructed of a similar material, installed via a manual, semi-automated or automated process. In FIG. 19 a winding machine and semi-automated process is shown.

The forces normally exerted on the original plug and cable junction are then transferred to the custom plug enclosure stress relief and cable sheath or spiral wrap.

The cable body between the plugs on each end of the cable is also protected. The body of one embodiment of the stress relief portion of the device also contains a number of round or oval detents which are incorporated at an angle in the stress relief section of the device and are sufficient to engage the cable without damage as the lid of the stress relief section is compressed into final locking position which is based upon the diameter of the cable. The device is readily assembled via placing the device over the existing plug and cable and sheath then by pushing down on the ratcheting mechanism compression until no further movement occurs.

The device strengthens the existing assembly against mechanical forces and helps prevent the leads of the cable from pulling out of the plug in an entirely cold process requiring minimal skill.

Although the custom plug enclosure device shape and size is minimalistic and based upon the shape of the outer surfaces of the plug to which it will adhere there exists a plurality of plug shapes and variations within each plug shape to which the custom plug enclosure must conform as seen in FIG. 8. The variability between plug manufactures within the range of the plug standard will be accommodated by the properties of the custom plug enclosure to be manufactured due to variations within a particular class of plug. When a plug is encountered that exceeds the geometry of the design specification for a particular class of plug a highly customized plug that meets the application could be manufactured via an additive manufacturing process and then by an injection molding process if demand necessitates.

The second embodiment is similar to the first except the custom plugs are replaced with a customized heat shrink material with properties specifically selected for the current application. The custom heat shrink material is placed over the plug, cable and sheath then carefully heated until the material conforms and secures the plug to the cable and to the protective personalization cable sheath which whose material of construction was previously detailed. The braid material expands and is pulled over the plug end to the required length to cover the cable then secured either by the distal portion of the stress relief mechanism portion of the custom component as in embodiment One FIG. 9 or by heat shrink material as in embodiment two FIGS. 12 and 13 in conjunction with a spiral wound stress relief component.

The wire wrap either sheath or spiral is pulled or wound around in a manual, semi-automated or automated process as in the case of the cold process as described earlier to cover the entire length of the cable and is attached in a similar manner regardless of embodiment the custom plug enclosure as embodiment One and embodiment Two FIG. 11.

The custom plug, heat shrink material, braid or wrap material which is available in a wide variety of colors including clear is also essential to the personalization aspect of the current device. The cable owner would have the option of selecting from a plethora of colors for each component of each embodiment to meet their personalization requirements.

Due to an additional and essential need to rapidly identify the cable and AC adapter among a host of similar appearing items as seen in FIG. 20 a provision will be made not only to customize the length of the cable but also the USB A plug and numerous variations of AC adapter itself commonly found inside and outside of North America via a standard or custom image which adheres to these areas suites the preferences of the end user. In embodiment One or Two the images will be placed over the USB A downstream plug and on the AC power supply as seen in FIG. 15.

### BRIEF DESCRIPTION OF THE DRAWINGS

In the drawings,

FIG. 1 is a side view of the different cable types that the current device remedies

FIG. 2 is a top view of a generalized cable with mobile device and power supply plug

FIG. 3 is a side view of FIG. 2.

FIG. 4 is a top side view of typical damage in the PIN area resulting from longitudinal mechanical force

FIG. 5 is a top side view of typical damage in the plug to cable area from axial mechanical force

FIG. 6 is a top view of typical damage along the cable body due to abrasive mechanical force

FIG. 7 is a top view of typical damage on the cable body due to cutting mechanical force

FIG. 8 is a perspective view of various mobile device side plugs and power side plug enclosure

FIG. 9 is a perspective view of a first exemplary embodiment of a custom plug enclosure for strengthening the mobile device side plug and cable in an entirely cold process

FIG. 10 is a perspective view of a first exemplary embodiment of a custom plug enclosure for strengthening the power side plug in accordance with the invention in an entirely cold process

FIG. 11 is a perspective view of a first exemplary embodiment including customized plug enclosure for strengthening and personalization of the cable along its length in accordance with the invention in an entirely cold process

FIG. 12 is a side view of a second exemplary embodiment for strengthening the mobile device side plug in a hot process

FIG. 13 is a side view of a second exemplary embodiment for strengthening the power side plug in a hot process

FIG. 14 is a perspective view of a second embodiment for strengthening and personalization of the cable along its length in an entirely cold process

FIG. 15 is a top view of an exemplary embodiment of personalization of the USB plug side of the cable and AC power supply

FIG. 16 is a side view of an exemplary embodiment of the personalization of two faces of an AC power supply

FIG. 17 is a sectioned detailed view of the charge cable, adapter and personalization on the cable body, USB plug and AC power supply

FIG. 18 is a perspective view of exemplary embodiments (round or flat) of the strengthening and personalization of the cable using fibrous material

FIG. 19 is a perspective view of exemplary embodiments of the strengthening and personalization of the cable using spiral sheath and a winding installation device

FIG. 20 is a perspective view of the personalization aspects of the device on the cable body, USB A adapter and AC power supply allowing easy identification among many similar devices

### DETAILED DESCRIPTION OF EXEMPLARY EMBODIMENTS

This present invention applies to mobile device cables and their associated power supplies. It provides a means to strengthen the cable against typical operational mechanical stress and prevent damage to the cable in the area of the pin to lead, plug to cable interface and along the entire length of the cable body in-situ without dismantling any pre-existing component.

It also provides a means to personalize the cable and associated AC adapter to meet the requirements of the user and provide a means of ready identification among a host of similar devices.

The strengthening and personalization components can be installed in a manual, semi-automated or automated process. Those skilled in the art can see that that modification can be made to the preferred embodiments One and Two including the exemplary images without departing from the spirit of the invention. The foregoing embodiments may be implemented individually or in any combination.

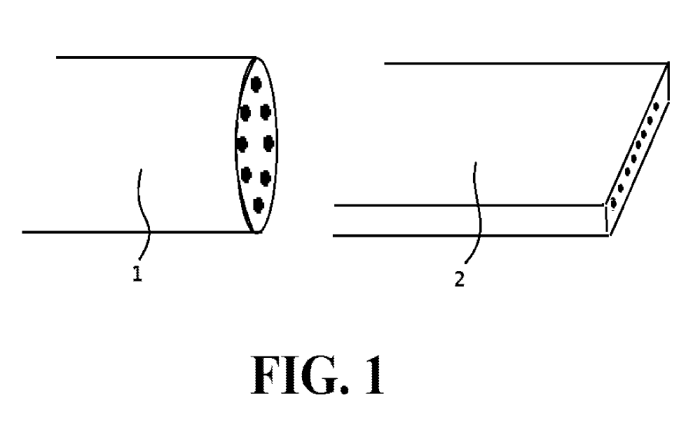

FIG. 1 shows two possible cable geometries for which the invention is intended. The cables contain a plurality of individually insulated wires. Cable 1 is round with diameter in the range of ⅛ to 3/16″. Cable 2 is flat with thickness in the range of 1/16 to 1/18 and approximate width of ¼″. Other dimensions are possible within a functionally reasonable range.

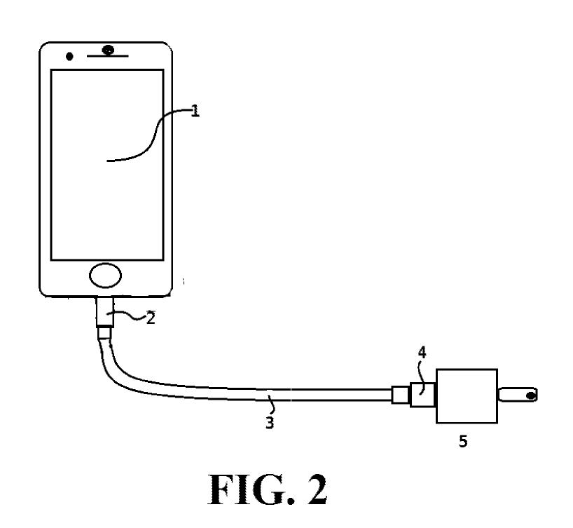

FIG. 2 shows a typical application of a mobile device cable that transfers data and power. Cable plug 2 of USB or custom type is inserted into the multifunction port of mobile device The cable 3 either round or flat as in FIG. 1 via downstream plug 4 which is typically of USB A type transfers power from the AC power supply 5.

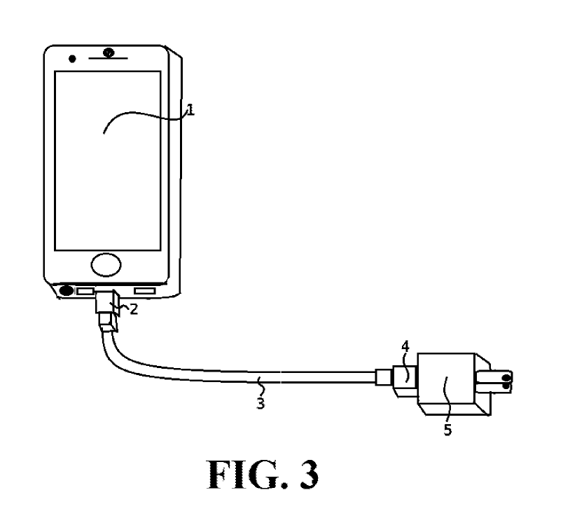

FIG. 3 is a bottom side view of FIG. 2. Cable plug 2 of USB or custom type is inserted into the multifunction port of mobile device 1. The cable 3 either round or flat as in FIG. 1 via downstream plug 4 which is typically of USB A type transfers power from the AC power supply 5.

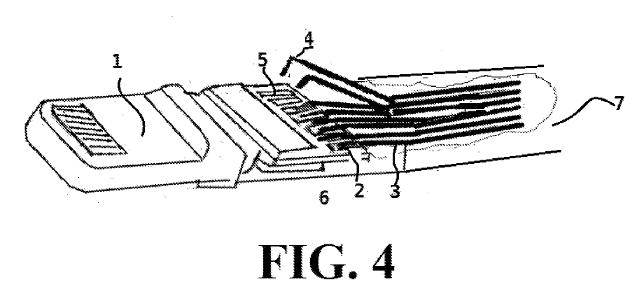

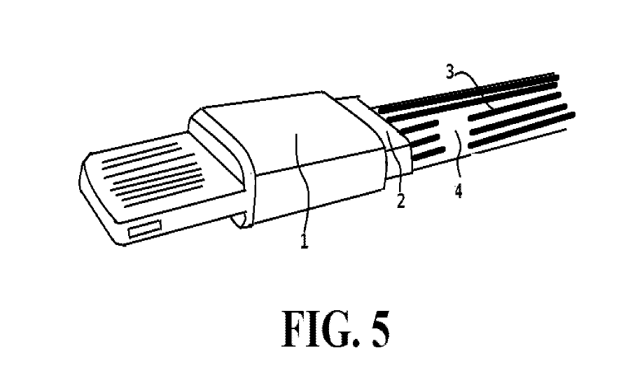

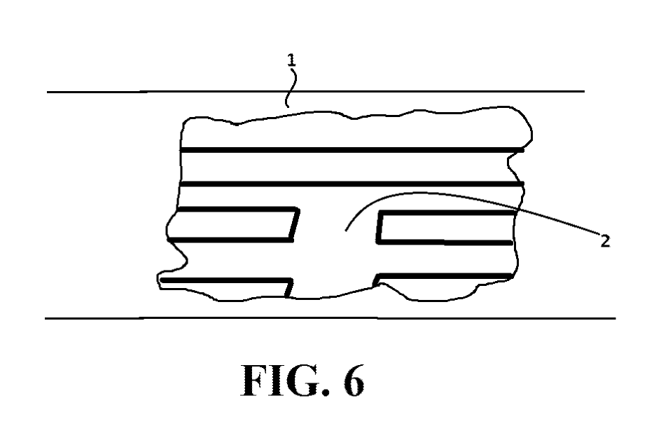

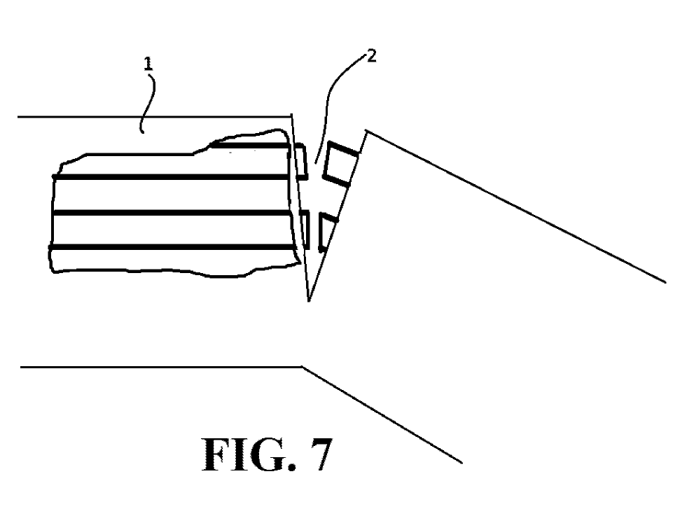

FIG. 4-7 show typical failures caused by longitudinal, axial, bending, abrasive and cutting mechanical forces of which the invention strengthens against. FIG. 4 shows a top cut away view of the plug 1 body. Leads in area 2 are attached to the corresponding contacts in area 3. Leads in area 4 have pulled out of contacts in area 5 potentially shorting the electronics board 6 rendering the cable 7 inoperable. Similar damage can occur to the downstream plug components. FIG. 5 shows an upstream plug 1 and preexisting plug to cable joiner 2 where the cable 3 has become damaged by rotational or bending forces leaving conductors in area of 4 exposed resulting in failure of the cable. FIG. 6 shows cable 1 worn by abrasive forces resulting in bare leads 2 and cable failure. FIG. 7 shows cable 1 and break due to cutting forces and results in cable failure.

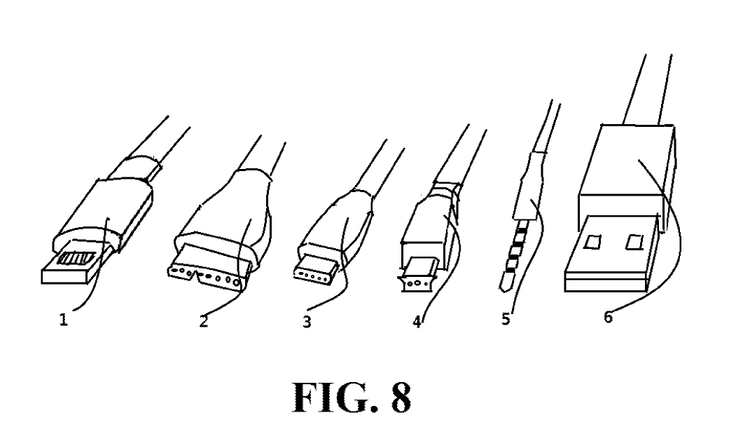

FIG. 8 demonstrates the commonly occurring plugs used on the Host side of the cable and include: 1. iPhone Lightening, 2. USB 3.0 type C, 3. USB micro type B, 4. USB Mini type B, 5. Phone plug and 6. USB type A. Plug of type USB A is commonly the only downstream plug to the AC power side of the cable.

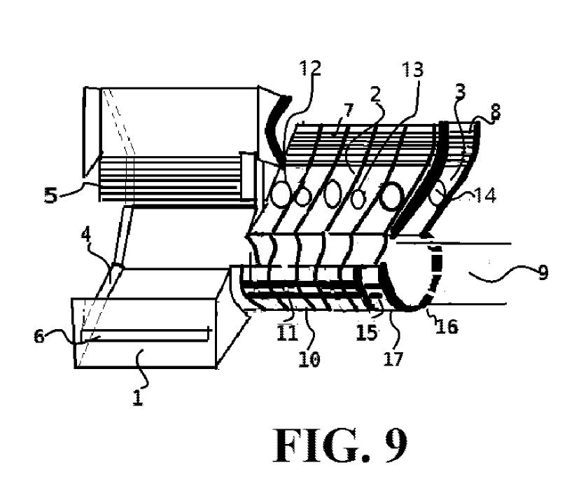

FIG. 9 shows an entirely cold installation process embodiment of plug enclosure component of the invention that is a physically low profile device enclosure that fits over and attaches to either the upstream or downstream plug and provides stress relief for the cable. The plug enclosure is available in a multitude of colors to meet the preference of the user. The plug enclosure consists of three parts: 1. Proximal which encloses the main body of the underlying plug, 2. the middle which encloses most of the cable and grasps onto the cable and 3. distal which grasps onto the protective sheath and underlying cable. The device may or may not contain adhesive in the various sections. Section one contains a lip 4 which prevents rearward movement when secured to the plug. Section 5 is a ratcheting and locking mechanism which applies captive force and immobilizes the body of the plug enclosure as the ratchet is pressed into its capture 6. The proximal portion of the enclosure consists of two equal parts each containing ratcheting mechanisms 7 and 8 that engage their respective capture 11 and 15 on side 10 and exert force on the enclosed cable 9 as the ratcheting mechanism is engaged. This design allows for sufficient force to be applied on the variation of each type of existing plug to secure the plug and cable. Retention ovals 12 and 13 increase captive force on the cable within the middle section of the stress relief mechanism. Captive force on the sheath which is inserted into the distal portion is also exerted by area 17. Oval 14 increases captive force on cable and sheath in the distal section. Gasket 16 rips onto and immobilizes the cable.

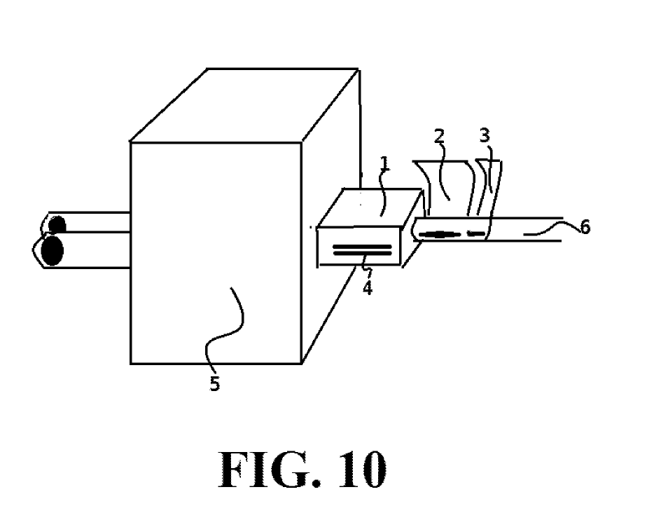

FIG. 10 shows the invention component cold process connection cover 1 with the ratcheting mechanism 4 engaged on the proximal area 1 and open in the middle 2 and distal 3. The invention is plugged into the AC adapter 5. The cable 6 is shown exiting the distal portion of the device.

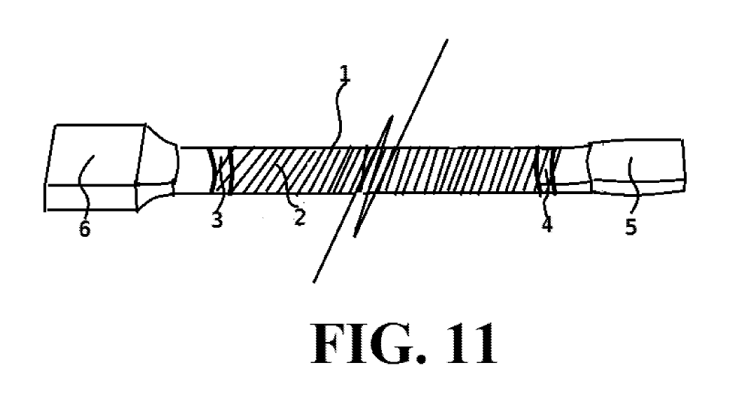

FIG. 11 shows the upstream side 5 and downstream side 6 hot or cold process device components. The protective sheath 2 covering the body 1 of the cable and engaged by the distal ends of the plug enclosures in areas 3 and 4 are also shown in a typical representation.

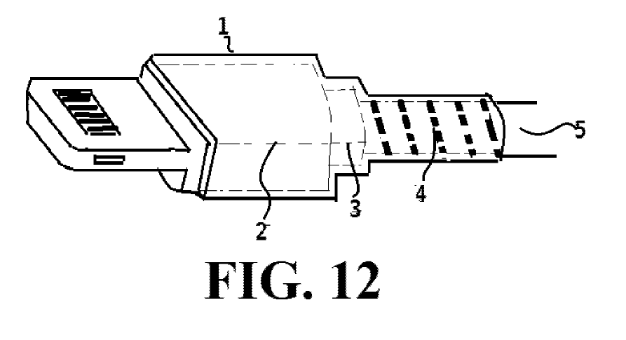

FIG. 12 shows a second embodiment of the invention 1 inclosing and adhering to all portions of an upstream plug 2 installed via a hot installation process, The device conforms to the plug body 2, the pre-existing plug to cable joiner 3, spiral stress relief component 4 and to the cable 5.

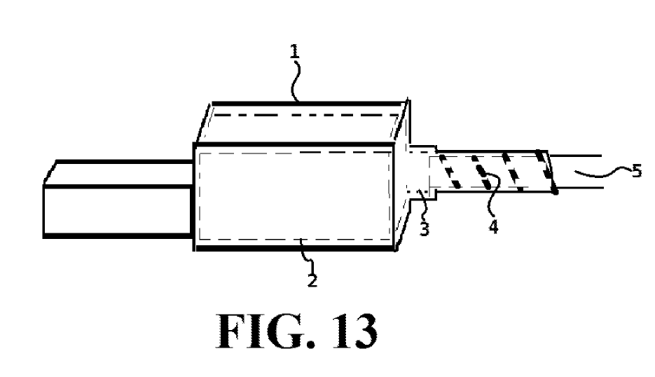

FIG. 13 shows a second embodiment of the invention 1 inclosing and adhering to all portions of a downstream USB A type plug 2 installed by a hot process. The device conforms to the plug body 2, the pre-existing cable joiner 3, spiral stress relief component 4 and to the cable 5.

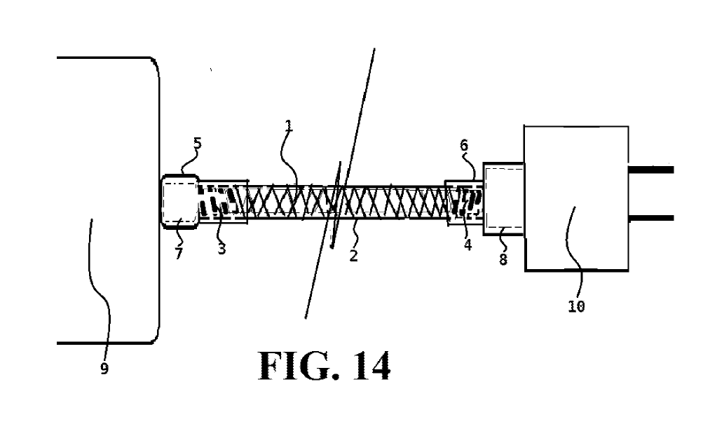

FIG. 14 shows an embodiment of the invention where a protective sheath 1 wraps a cable 2 and covers the spiral stress relief components 3 and 4. The heat shrink plug enclosure 5 and 6 cover the upstream 7, downstream 8 plugs, spiral stress relief 3 and 4 components and each terminus of the cable sheath 1. The upstream plug 7 is inserted into the host device 9 and the downstream plug 8 is inserted into the downstream AC power supply 10.

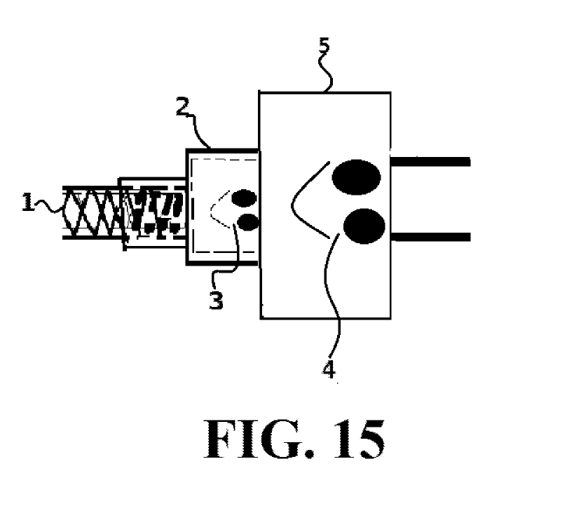

FIG. 15 shows the personalization components of the invention. The sheath 1 available in multiple colors, the USB A device enclosure 2 of embodiment One or Two available in colors to the preference of the user and the generic images 3 and 4 covering the USB A area and power supply 5, respectively.

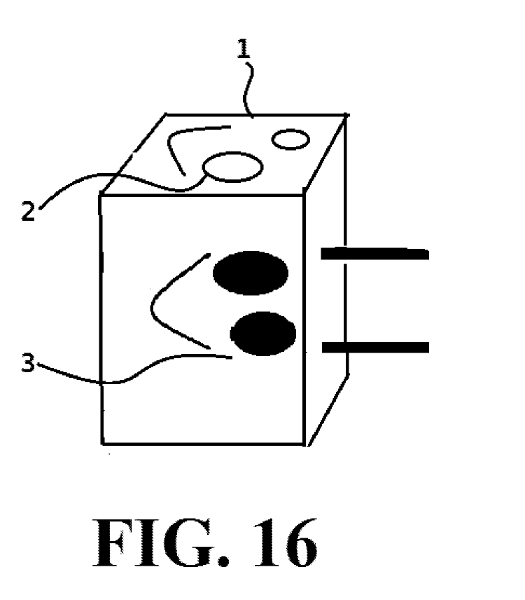

FIG. 16 shows the AC power supply 1 personalized by a representative generic image 2 and 3.

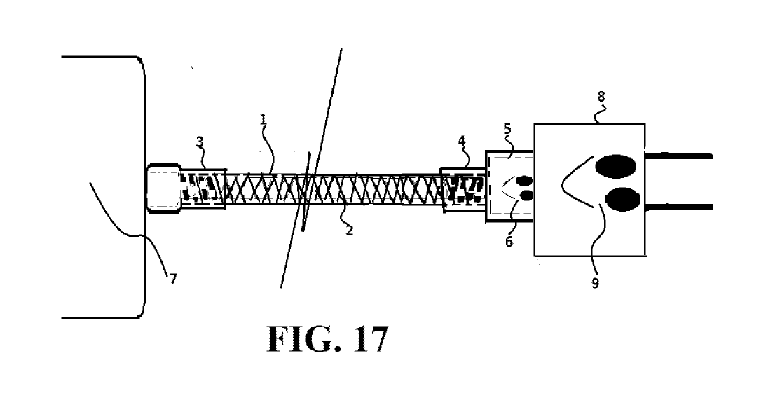

FIG. 17 shows the fully assembled invention of embodiments One or Two. Cable 1 is wrapped by protective and personalization covering 2 and inserted into the distal ends of the enclosure 3 and 4. Downstream plug 5 is personalized by representative image 6. The plugs are inserted into the upstream host device 7 and downstream power supply 8. The power supply 8 is personalized by representative image 9.

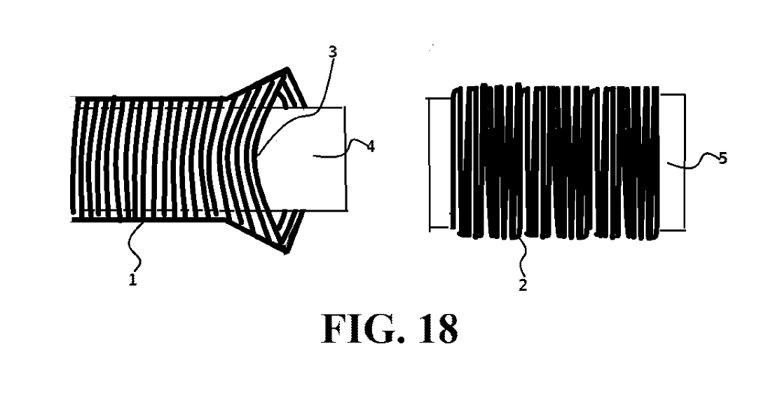

FIG. 18 shows the protective and personalization cable sheath 1 and spiral winding 2. One end 3 of the sheath 1 has been expanded to easily slide over the smaller plug of the cable 4. The spiral winding 2 is wound onto the body of the cable 5. Either material is cut into the appropriate length Installation is by a manual, semi-automatic or automatic process.

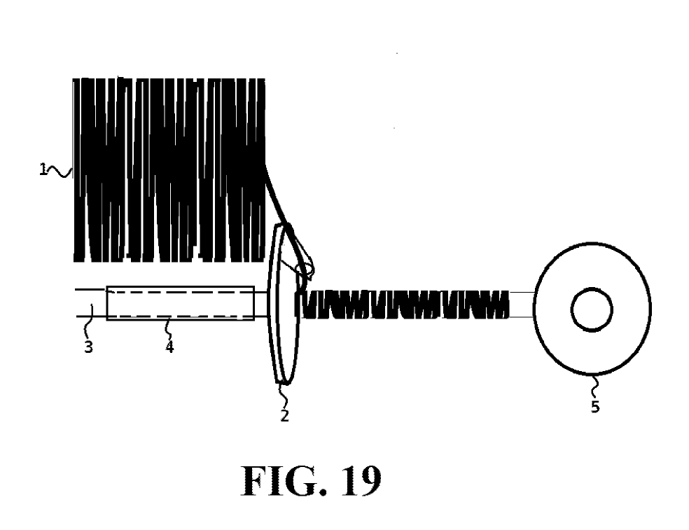

FIG. 19 is a perspective view of exemplary embodiments of the strengthening and personalization of the cable using spiral winding and a diagrammatic representation of a semi-automated winding installation device. Spiral winding 1 is feed to the winder 2 which rotates around the cable 3 as tension is applied by the tensioner 4 as the finished cable is wound about spool 5

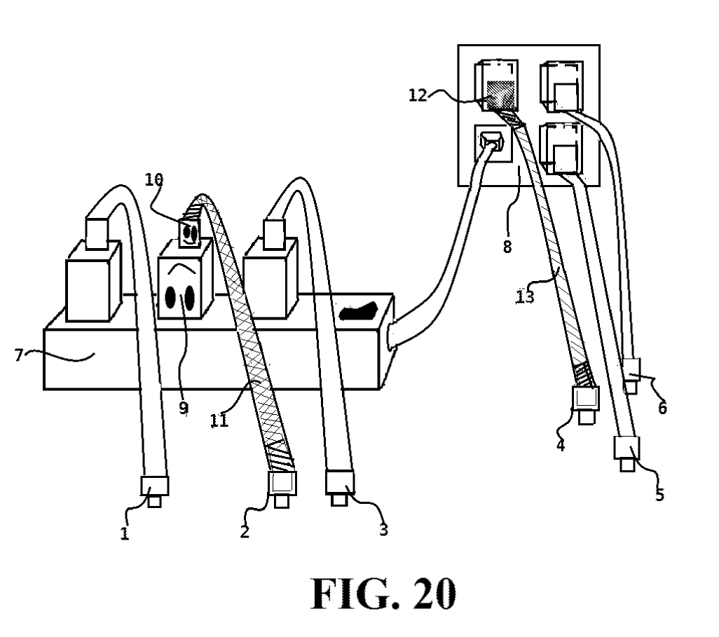

FIG. 20 shows typical congregation of numerous similar appearing cables and AC power supplies plugged into wall outlet 8 and extension outlet 7 in close proximity. The personalization components of the invention consisting of sheath 11, downstream image 10 and generic image 9 on the AC adaptor on cable 2 and sheath 13 and user created downstream image 12 on cable 4 allow the personalized devices which connect to mobile devices for example such smart phones, smart watches, tablets and as mentioned elsewhere above to permit readily identification among numerous devices with similar appearance.

That which is claimed is:

1. A device that reinforces and personalizes a charge and synchronization cable and associated AC power supply for mobile devices and associated inductive charging device cables that can be installed without altering existing components and superimposed over in a manual, semi-automated or automated process, can exist in several embodiments and a person skilled in the art can realize that more forms of the same device can exist that adhere to the spirit of said device. The invention comprises: plug enclosures bodies, sheath and images. The enclosure body can consist of three segments: proximal, middle and distal and encases the downstream and upstream plugs of a mobile device and attaches to the cable and a protective sheath. The device has a physically low profile to conform to existing plugs. The enclosure device can be one piece with no articulations or contain a top and a bottom and these halves are connected on one side. The device is made via extrusion, injection molding, additive manufacturing or stamping and is made from plastic, fibrous or metallic material and can be available in a number of sizes for each plug type as required by the plurality of and variation within each type of plug to which the device must conform. The device components are available in a number of colors to meet the personalization requirements of the end user.

2. The device of claim 1 can contain for a cold assembly process a ratcheting tensional mechanism on the front, the middle and distal portions of the plug enclosure which alone or in conjunction with other components applies sufficient force to immobilize the plug, cable and sheath that are enclosed.

3. The device of claim 1 for a cold assembly process distal end can contain a number of projections. The projections are arranged in such a way as to grip a cable that runs through the center when the two halves of the device are in the closed and in locked position.

4. The device of claim 1 can for a cold process attach via crimping the plug enclosure components to the cable and plugs on each end of the cable.

5. The device of claim 1 for a hot assembly process front, the middle and distal portions of the plug enclosure components which alone or in conjunction with other components applies sufficient force to immobilize the plug, cable and sheath that are enclosed.

6. The device of claim 1 for a hot assembly process contains a spiral winding for stress relief immediately after the USB or custom plug along the body of the cable.

7. The device of claim 1 contains a protective sheath. The mechanical forces routinely occurring in usage of the cable are transferred to the device components including spiral winding where applicable and sheath and in doing so strengthens the junction between the cable and the upstream of downstream plugs.

8. The device of claim 1 which contains a protective sheath also protects the cable from forces normally occurring along the entire length of the cable. Additionally, the sheath is available in a number of colors which provides personalization of the cable.

9. The device of claim 1 also provides a provision for personalization via attachment of a desired image surface of the plug enclosure components and associated AC power supply. Personalization of the components permits easy identification among a host of similar cables and adapters.

10. A method to install the strengthening and personalization components of the device in embodiment One for a cold process includes said steps to install the sheath, upstream and downstream plug enclosure components and images. Install the protective sheath over the entire length of the cable. Install the USB A plug enclosure component, tension and activate by ratcheting the USB A body section downward until no further movement can occur and lock. Repeat the activating action on the middle portion of the USB A portion of the plug enclosure. Insert the sheath into the distal portion of the plug enclosure and repeat the activating action to the distal portion of the enclosure securing the cable and sheath and lock. Repeat the procedure on the upstream plug enclosure to host plug with the following exception. Pull the sheath tightly then insert into the distal portion of the device and cut off the excess sheath material. Apply tension and activate the device by ratcheting the distal portion of the device securely and lock. Install the user defined image to the outer surface of the device covering the USB A plug. Now install the user defined image to the outer surface of the AC adaptor.

11. A method to install the strengthening and personalization components of the device in embodiment Two for a hot process includes said steps to install the sheath, upstream and downstream device components and images. Install the sheath over the cable. Install the USB A heat shrink component. Install a small section of spiral wound material starting immediately adjacent to the USB A plug along the body of the power cable. Insert a section of the spiral winding into the terminus of custom heat shrink device and cover the spiral winding. Conform the heat shrink device to the USB A plug, cable and sheath via applying heat not in excess of 190 degree F. to the heat shrink component by rotating the cable to and fro through the heat source taking care not to overheat the cable or USB A plug. Stop when the heat shrink component applies sufficient tension to the USB A plug, the cable and sheath. Install the heat shrink component over the upstream plug. Insert the sheath into the heat shrink component and cut off the excess sheath material. Conform the heat shrink component to the cable and sheath as previously described. Install the personalization images to the outer surface of the heat shrink device and AC adaptor as previously described.
